(19) United States
(12) Patent Application Publication
(10) Pub. No.: US 2011/0050432 A1
(43) Pub. Date: Mar. 3, 2011

(54) INTERACTIVE APPARATUS FOR USE WITH A URINAL

(76) Inventors: Gordon MacSween, Chelmsford (GB); Mark Melford, London (GB)

(21) Appl. No.: 12/990,937

(22) PCT Filed: May 6, 2009
(86) PCT No.: PCT/GB09/01116

§ 371 Date: Nov. 3, 2010

(30) Foreign Application Priority Data
May 7, 2008 (GB) 0808309.9

(51) Int. Cl. G08B 21/00

(52) U.S. Cl. 340/603

(57) ABSTRACT

An interactive apparatus for a urinal comprises one or more non-contact passive infra-red sensors, computing means and a display. The one or more non-contact passive infra-red sensors are arranged to detect a flow of liquid within one or more zones and to output a signal corresponding to the target zone or zones in which the flow of liquid has been detected. The zones are located in the vicinity of a urinal receptacle. The computing means receives the signal from the one or more non-contact passive infra-red sensors, processes some or all of the signals from the one or more non-contact passive infra-red sensors and produces an output signal. The output signal is output to the display. A method for carrying out the invention is disclosed.

This invention relates to an interactive apparatus for use with a urinal and a method of operating an interactive apparatus for use with a urinal.

Urinals are well known in gentlemen's lavatories. In addition, forms of control apparatus for use with a urinal are also well known. For example, it is common to use a sensor to identify when a urinal user leaves the vicinity of the urinal in order to actuate flushing of the urinal. Additionally, it has become common in recent years to provide advertising media in the vicinity of a urinal, particularly since the urinal user represents a captive audience. Moreover, such advertising can be highly targeted to a particular audience, depending on the location of the urinal. The use of detection means for use with a urinal to activate a display of advertising material has also been disclosed. One such example is described in GB 2 415 080. This document also describes the use of sensors to detect the location of a flow of urine into a urinal. Sensing the urine is achieved using contact sensors such as mechanical flow sensors which must necessarily be mounted within a urinal bowl.

Most conventional urinal bowls are fabricated in ceramic or metal and involve an ergonomically contoured surface which is easy to clean. Detailed surface features are usually avoided since they are more difficult to clean and so are likely to be less hygienic. A disadvantage of the apparatus of GB 2 415 080, where sensors are placed in the urinal bowl, is that the sensors (a) will inevitably come into contact with urine in the urinal bowl and (b) will result in small, detailed features within the urinal bowl. This will make the task of cleaning the urinal bowl more difficult and will result in a less hygienic urinal bowl.

The present invention provides an interactive apparatus for a urinal, the interactive apparatus comprising:
one or more non-contact passive infra-red sensors;
computing means; and
a display;

wherein the one or more non-contact sensors are arranged to detect a flow of liquid within one or more zones and to output a signal corresponding to the zone or zones in which the flow of liquid has been detected;

and wherein the one or more zones are located in the vicinity of a urinal receptacle;

and wherein the computing means receives the signal from the one or more passive infra-red non-contact sensors, processes some or all of the signals from the one of more non-contact sensors, and produces an output signal;

and wherein the output signal is output to the display.

An advantage of the present invention is that it involves the use of non-contact sensors which can be placed outside the urinal receptacle. This is both (a) more hygienic than the prior art and (b) means that the invention can easily be retro-installed in the vicinity of an existing urinal receptacle without the need for any alterations to the urinal receptacle. In addition, the location of the sensors can be unobtrusive and will therefore not distract users who have no interest in the interactive functions of the present invention.

Preferably, the one or more non-contact sensors are located outside a urinal receptacle.

Preferably, the one or more non-contact sensors are located above a urinal receptacle.

Preferably, the one or more non-contact sensors detect the flow of liquid by detection of a change in sensed temperature caused by the presence of the flow of liquid.

Preferably, the flow of liquid within each zone is detected by one of the one or more sensors.

In one embodiment, one or more of the one or more zones is three-dimensional.

Preferably, one or more of the one or more zones is conical or frusto-conical.

In another embodiment, one or more of the one or more zones is two-dimensional.

In either embodiment, preferably, the interactive apparatus comprises three or more sensors.

Preferably, the one or more sensors comprise lensed optics.

Preferably, the one or more sensors provide a ratio of diameter of the widest part of the zone to the distance from the sensor to the widest part of the zone of less than or equal to 1:8, preferably less than or equal to 1:10, more preferably less than or equal to 1:12.

Preferably, the interactive apparatus further comprises a urinal bowl, urinal trough or similar receptacle for urine.

Preferably, the urinal bowl, urinal trough or similar receptacle for urine comprises marking indicating to a user the location of some part of one or more of the one or more zones.

A further aspect of the present invention provides a method of operating an interactive apparatus of the type comprising a urinal, computing means, one or more non-contact passive infra-red sensors and a display, comprising the steps of:

operating the one or more non-contact passive infra-red sensors to detect flow of a liquid within one or more zones wherein the one or more zones are located in the vicinity of a urinal receptacle;

on detection of the flow of liquid the one or more sensors sending one or more signals to the computing means indicative of the zone or zones in which liquid has been detected,

the computing means processing the one or more signals from the one or more sensors and outputting control instructions to the display thereby controlling operation of the display.

In one embodiment the one or more sensors detect the flow of liquid by detecting a change in sensed temperature caused by the presence of the flow of liquid.

Preferably, the flow of liquid is used to control activation of the display.

Preferably, the flow of liquid is used to control the contents of the display.

Preferably, the flow of liquid is used to control navigation by a user through contents displayed on the display.

Preferably, the display displays an interactive game, advertisement, or similar.

Embodiments of the present invention will now be described, by way of example only, with reference to the accompanying drawings, in which:

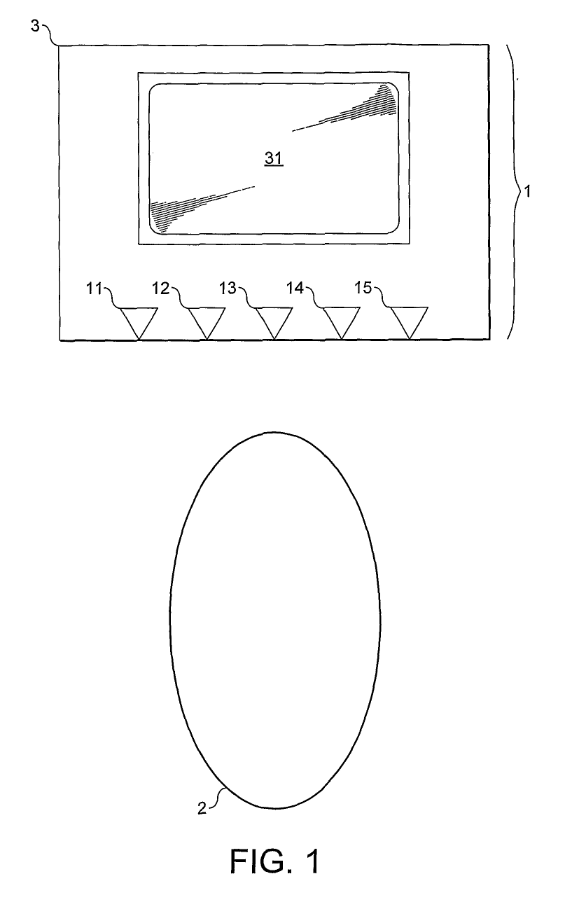

FIG. 1 is a schematic view of an embodiment of the present invention showing a conventional single urinal bowl above which are mounted in a single unit five non-contact passive infra red (PIR) sensors and a display; and

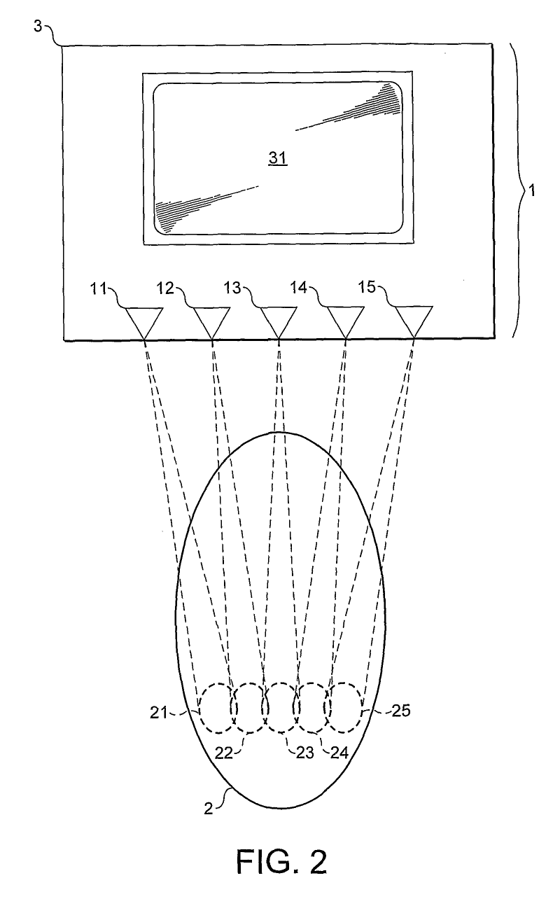

FIG. 2 is based on FIG. 1 but, in addition, shows the five zones (in broken lines) which correspond to the five non-contact sensors.

FIG. 1 shows an embodiment of the interactive apparatus 1 in situ with a conventional urinal 2. The interactive apparatus is enclosed in a housing 3 such as a box or section of a wall. The interactive apparatus comprises five non-contact sensors 11, 12, 13, 14 and 15, in the form of passive infra-red (PIR) sensors, computing means (within the housing 3) and a display 31.

FIG. 2 shows all the features of FIG. 1 and, in addition, FIG. 2 shows the five zones 21, 22, 23, 24 and 25. In general, a ‘zone’ is an area or volume of space covered by a single sensor 11, 12, 13, 14 and 15 and represents the volume in which the sensor is able to detect a target such as urine. In the specific embodiment of FIG. 2, each of the five zones is conical with an elliptical base. The zone may by frusto-conical rather than conical and the base of the cone or frustum may be circular, elliptical or any other shape.

Typically, the urinal 2 has a lower rim which is situated at a height of approximately 610 mm above the floor on which the user stands. The PIRs have a particular angular degree of coverage dependent on sensor type and whether the PIR contains lenses. A useful measure is the ratio of diameter of the widest part of the zone to the distance from the sensor to the widest part of the zone. In this embodiment, each zone is of a cone shape and the widest part of the zone is therefore the base of the cone. It has been found that this ratio is important in order to allow for suitably sized zones and to allow for adequate clearance between the urinal bowl and the sensors. It is preferred that the ratio is smaller than 1:8, preferably 1:10 and more preferably 1:12. Each target zone may overlap with its nearest neighbouring zone(s).

The conventional urinal 2 is of a type such as a Twyfords VC7003 Camden urinal. An example of suitable PIR sensors 11, 12, 13, 14 and 15 is the Optris CS PIR sensor which senses the long wavelength radiation (of wavelength 8 to 14 μm) emitted by any warm body.

Since the non-contact sensors 11, 12, 13, 14 and 15 are PIR sensors it is not possible for a user to identify the size, shape, perimeter or relative positions of each of the zones 21, 22, 23, 24 and 25 unless the zones 21, 22, 23, 24 and 25 were defined by other means within the urinal bowl 2. For example, in the case where the zones are a three-dimensional cone, the means for identification might be to indicate the perimeter of the base of the cone at the point where the cone intersects the urinal bowl. It would be possible but by no means necessary to provide such means for identification.

The computing means receives the signals from the five non-contact PIR sensors 11, 12, 13, 14 and 15 and produces an output signal which governs what appears on the display. The computing means may be a microprocessor chip. For example, the computing means may be a standard PIC microprocessor. Alternatively, the computing means may comprise more than one component. For example, the computing means may comprise (a) a standard PIC microprocessor for receiving and processing the signals from the sensors and (b) a standard PC for running the media content in response to the processed signal derived from the PIC.

In use, when the user directs a flow of urine into the bowl 2 the flow will hit the bowl in one or more of the zones 21, 22, 23 24 and 25. The corresponding PIR sensor or sensors 11, 12, 13, 14 and 15 detects this flow due to the difference between the temperature of the urine and the room temperature. A signal is produced by each sensor 11, 12, 13, 14 and 15 and sent to the computing means. The computing means receives the five signals from the five sensors and uses a detection algorithm to identify the location of the flow of urine. If urine is detected in more than one zone at any one time, algorithms in the computing means determine the one zone in which there is the greatest evidence of a urine stream being present. The algorithms are designed to account for unwanted side-effects caused by signal clutter from, for example, splash back.

The sensors are capable of sensing the flow of urine when the temperature differential between the urine and the ambient is relatively small. In tests, it has been shown that at flow rate of 25 ml s⁻¹ a temperature difference of as little as 3 ° C. is enough to allow for consistent and reliable detection.

In this embodiment there is a further proximity sensor (such as an optical, PIR or ultrasound sensor, not shown in the figures) which detects the presence of a user arriving at the urinal station. Once this sensor detects the presence of a user, it sends a signal to the computing means.

The computing means is able to output to the display 31 signals for displaying a computer game or advertising media or a combination of both. The instruction code may either be pre-programmed in memory or obtainable in real time via a network connection. The computing means also initiates a welcome sequence to be displayed on the screen when the proximity sensor indicates that a user has arrived at the urinal station.

The computing means is also able to receive information, via a network connection, to determine the nature of the advertising media to be shown on the display 31. The data received may include the outside temperature and the volume of produce sold by the establishment at which the apparatus 1 is installed. This information is used, together with details such as the time of day and the day of the week, to influence the advertising material to be shown on the display 31. In addition, the computing means may transmit information, such as data regarding the use of the apparatus and the popularity of games and advertising, via the network.

The display 31 may be a liquid crystal display, a plasma screen or any other form of display. The user interacts with the computer game or advertising media through controlling the direction of urine flow.

For example, where the invention is used to control a game, the display 31 might display an animated character or animated vehicle which would change direction in response to the direction of the flow of urine into the urinal bowl. Advertisements may be placed before, during or after the game. Where advertisements are placed during the game then may be around the periphery or embedded within game's images. When the urinal station is not in use, the display 31 may be used to show media (including advertising) which are not interactive.

Alternatively, where the display is used predominantly for advertising, the user may direct the flow of urine: (a) within the centre-right zone 24 or far-right zone 25 in order to progress to the next page of advertising; (b) within the centre zone 23 to maintain the current page of advertising; and (c) within the centre-left zone 22 or the far-left zone 21 to return to the previous page of advertising. Alternatively, the user might, for example, be presented with five icons in a row from left to right on the display 31, wherein each option represents a different advertisement. The user would then direct the flow of urine within the zone whose relative position in the urinal bowl 2 was closest to the relative position of the icon of choice. Again, when the urinal station is not in use, the display 31 may be used to show media (including advertising) which are not interactive.

Alternative embodiments of the invention may involve any number of non-contact sensors. The sensors may be photoelectric detectors or any other form of passive sensor. The sensors need not be passive sensors. For example, the sensors may function by emitting radiation and detecting the radiation reflected by the urinal bowl and the flow of urine.

The sensors may be arranged such that there is no overlap between adjacent zones. The sensors and/or the zones may be arranged in any formation including a line and a matrix. The relative location of the non-contact sensors may not be the same as the relative location of the corresponding zones.

A further alternative embodiment may use a single sensor comprising photoelectric detectors in a charge coupled device (CCD) array.

As an alternative to detecting the urine in flight, the sensor or sensors may be arranged to detect the flow of urine only once it makes contact with the urinal bowl. In other words, the zones may be two-dimensional areas (on the surface of the urinal bowl) rather than three-dimensional volumes of space.

Other alternatives may involve a larger ratio of diameter of the widest part of the zone to the distance between the sensor and the widest part of the zone.

The output signal produced by the computing means may be a video signal and may include an audio signal.

In an alternative embodiment of the present invention, the interactive apparatus may be used with a trough-style urinal suitable for use simultaneously by more than one urinal-user. It would also be possible to use more than one interactive apparatus with a trough-style urinal.

It would also be possible for multiple interactive apparatuses to be networked together in order to be used to operate a game in a multi-player mode. The networked interactive apparatuses may be physically adjacent or at any alternative location.

1. An interactive apparatus for a urinal, the interactive apparatus comprising:
one or more non-contact passive infra-red sensors;
computer means for receiving and processing signals from the one or more non-contact passive infrared sensors
a display;
the one or more non-contact passive infra-red sensors are arranged to detect a flow of liquid within one or more zones and to output a signal corresponding to the target zone or zones in which the flow of liquid has been detected;
the one or more zones are located in a vicinity of a urinal receptacle; and
the computing means receives the signal from the one or more non-contact passive infra-red sensors, processes some or all of the signals from the one of more non-contact passive infra-red sensors, and produces an output signal;
wherein the output signal is output to the display.

2. The interactive apparatus of claim 1 wherein the one or more non-contact sensors are located outside a urinal receptacle.

3. The interactive apparatus of claim 2 wherein the one or more non-contact sensors are located above a urinal receptacle.

4. The interactive apparatus of claim 1 wherein the one or more sensors detect the flow of liquid by detection of a change in sensed temperature caused by presence of the flow of liquid.

5. The interactive apparatus of any preceding claim 1 wherein flow of liquid within each zone is detected by one of the one or more sensors.

6. The interactive apparatus of claim 1 wherein the flow of liquid within each zone is detected by two or more of the one or more sensors.

7. The interactive apparatus of claim 1 wherein one or more of the one or more zones is three-dimensional.

8. The interactive apparatus of claim 7 wherein one or more of the one or more zones is conical or frusto-conical.

9. The interactive apparatus of claim 1 wherein one or more of the one or more zones is two-dimensional.

10. The interactive apparatus of claim 1 wherein one or more of the one or more zones are identified by means visible to a user.

11. The interactive apparatus of claim 1 wherein one or more of the one or more zones are identified by non-visible means to a user.

12. The interactive apparatus of claim 1 comprising three or more sensors.

13. The interactive apparatus of claim 1 wherein the one or more sensors comprise lensed optics.

14. The interactive apparatus of claim 1 wherein the one or more sensors provide a ratio of diameter of a widest part of the one or more zone to a distance between the sensor and the widest part of the zone of less than or equal to 1:12.

15. The interactive apparatus of claim 1 wherein the one or more non-contact sensors, the display and the computing means are contained in a single unit.

16. The interactive apparatus of claim 1 wherein the one or more non-contact sensors and the computing means are contained in a single unit.

17. The interactive apparatus of claim 1 wherein the display is selected from the group consisting of: monitors, television screens, LCD panels and similar.

18. The interactive apparatus of claim 1 further comprising a member selected from the group consisting of urinal bowls, urinal troughs and similar receptacles for urine.

19. The interactive apparatus of claim 18 wherein the member of the group consisting of urinal bowls, urinal troughs and similar receptacles for urine comprises marking indicating to a user the location of some part of one or more of the one or more zones.

20. A method of operating an interactive apparatus of the type comprising a urinal, computer means for receiving and processing signals, one or more non-contact passive infra-red sensors and a display, comprising the steps of:
operating the one or more non-contact sensors to detect flow of a liquid within one or more zones, wherein the one or more zones are located in the vicinity of a urinal receptacle;
on detection of the flow of liquid the one or more sensors sending one or more signals to the computing means indicative of the zone or zones in which the liquid has been detected; and
the computing means processing the one or more signals from the one or more sensors and outputting control instructions to the display thereby controlling operation of the display.

21. The method of operating an interactive apparatus of claim 20 wherein the one or more sensors detect the flow of liquid by detecting a change in sensed temperature caused by the presence of the flow of liquid.

22. The method of operating an interactive apparatus of claim 20 wherein the flow of liquid is used to control activation of the display.

23. The method of operating an interactive apparatus of claim 20 wherein the flow of liquid is used to control contents of the display.

24. The method of operating an interactive apparatus of claim 23 wherein the flow of liquid is used to control navigation by a user through contents displayed on the display.

25. The method of operating an interactive apparatus of claim 20 wherein the display displays a member selected from the group consisting of interactive games, advertisements, combination of the two and similar.

26. The interactive apparatus of claim 1 wherein the one or more sensors provide a ratio of diameter of a widest part of the zone to a distance between the sensor and the widest part of the zone of less than or equal to 1:8.

27. The interactive apparatus of claim 1 wherein the one or more sensors provide a ratio of diameter of a widest part of the zone to a distance between the sensor and the widest part of the zone of less than or equal to 1:10.
